(19) United States
(12) Patent Application Publication
(10) Pub. No.: US 2007/0173395 A1
(43) Pub. Date: Jul. 26, 2007

(54) Packaging of the stickpack type with improved opening and method for manufacturing the same

(75) Inventors: Elena Peron, Schio (IT); Carlo Alberto Zaggia, Vicenza (IT)

Correspondence Address: MODIANO & ASSOCIATI, Via Meravigli, 16, MILAN, 20123, IT

(73) Assignee: ALCAN PACKAGING ITALIA S.R.L.

(21) Appl. No.: 11/730,219

(22) Filed: Mar. 30, 2007

Related U.S. Application Data
(62) Division of application No. 10/801,664, filed on Mar. 17, 2004.

(30) Foreign Application Priority Data
Mar. 28, 2003 (IT) PD2003A000066
Jul. 15, 2003 (IT) PD2003A000160

(51) Int. Cl. B31B 21/26

(52) U.S. Cl. 493/254

(57) ABSTRACT

A packaging of the Stickpack type and the like with improved opening, which comprises a single- or multilayer flexible film that forms a hermetically sealed tubular body provided longitudinally with a first sealing band, of the inside/outside type or of the inside/inside type, of mutually opposite longitudinal flaps of the film and provided transversely with second sealing bands of the inside/inside type; a sealed extension region protrudes from at least one of the second sealing bands on a respective portion of at least one edge of the tubular body, and, in longitudinal alignment with the sealed extension region, transverse preweakening incisions are provided along at least one of the mutually opposite longitudinal flaps.

This is a divisional of the U.S. application Ser. No. 10/801,664, filed on Mar. 17, 2004.

The present invention relates to a packaging of the Stickpack type and the like with improved opening and to the method for manufacturing it.

Among the various types of packaging for products in granular or powder form, a type known as Stickpack is currently widely used commercially.

This Stickpack packaging is preferably used to package products such as coffee, sugar, drugs or other products in a single-dose quantity.

Its manufacture is per se relatively simple.

In a conventional packaging machine, preferably of the vertical type, a single- or multi-layer laminated flexible film is folded around the forming collar, which also acts as a filler tube.

Longitudinal closure is performed by overlapping the opposite flaps of the flexible film, heat-sealing the inside flap on the outside flap.

In order to achieve this seal, commonly known as inside/outside sealing, both surfaces of the initial film must have sealing properties.

Transverse sealing of the bottom is then performed, followed by filling with product and by transverse sealing of the top of the packaging.

Another longitudinal closure of the packaging is performed by overlapping the opposite inside flaps of the flexible film, heat-sealing the inside flap onto the inside flap: this seal is known as inside/inside sealing.

These packagings have a problem linked to their opening.

In order to access the packaged product it is in fact necessary to tear said packaging below the transverse sealing line.

This operation is sometimes facilitated by preweakenings that are provided on the edge of the packaging (on an extension of the sealed region).

However, when the tear reaches the longitudinal seal region, said tear tends to continue along the side of the longitudinal seal region, causing uneven opening with probable loss of the contained product.

Various technical solutions are known in order to allow easy opening of this type of packaging.

For example, solutions are known which provide for the yielding of the material by means of laser-generated or mechanical incisions.

Moreover, solutions are known that provide for the insertion of a transverse strip proximate to the top so as to guide the opening action.

All these technical solutions for assisted opening of the Stickpack packagings in any case suffer from drawbacks.

Solutions that provide for yielding are in fact currently very onerous, since they require the film printing machines to have equipment dedicated to each specific type and size of packaging.

Moreover, the risks linked to the use of laser technology in the field of packaging are known; if the initial film is a monolayer, there is the risk of generating microperforations in it.

In the case of multiple layers, instead, there is the risk of delaminations, with consequent alteration of the barrier properties of the layers.

Finally, solutions that provide for the insertion of a strip require modifying the packaging machines.

### SUMMARY OF THE INVENTION

The aim of the present invention is to provide a packaging of the Stickpack type and the like with improved opening that solves the opening problems and drawbacks of known types of packaging of the Stickpack type.

Within the aim, an object of the present invention is to provide a packaging of the Stickpack type and the like with improved opening that is sealed perfectly and does not have tearing or delaminations in the layers of the film that composes the packaging.

Another object of the present invention is to provide a method for providing a packaging of the Stickpack type and the like with improved opening that is economically advantageous with respect to methods currently in use for providing equivalent commercially available packagings.

Another object of the present invention is to provide a method for manufacturing packagings of the Stickpack type and the like that uses machines that are simple to manufacture and derive from known systems and technologies.

This aim and these and other objects that will become better apparent hereinafter are achieved by a method for manufacturing packagings of the Stickpack type and the like, wherein between the unwinding of a single- or multilayer film to provide a partial packaging and the sealing of said partial packaging by means of longitudinal and transverse seals in order to obtain a hermetically sealed packaging, it consists in providing transverse incisions on at least one of the longitudinal mutually opposite flaps of said film.

The above aim and objects are also achieved by a method for manufacturing improved packagings of the Stickpack type and the like, wherein a single- or multilayer film is unwound to manufacture a partial packaging and transverse incisions are provided on said film on at least one of the mutually opposite flaps of said film, said method comprising the steps of:
sealing longitudinally said partial packaging by virtue of a first band of sealing of said mutually opposite flaps of the inside/inside type;
applying onto at least one portion of the outer surface of said partial packaging a longitudinal adhesive layer at and proximate to said first sealing band;
folding, with respect to a longitudinal axis, said first sealing band on the outer surface of said partial packaging on the side of said adhesive layer;
gluing said first sealing band to said at least one outer surface portion by activating said adhesive layer, transversely sealing said partial packaging with second sealing bands, and providing a weakening pre-cut on at least one sealed extension region of at least one of said second sealing bands.

### BRIEF DESCRIPTION OF THE DRAWINGS

Further characteristics and advantages of the present invention will become better apparent from the following detailed description of a preferred but not exclusive embodiment thereof, illustrated by way of non-limiting example in the accompanying drawings, wherein:

FIG. 1 is a front view of the packaging according to the invention during a step of its manufacture;

FIG. 2 is a front view of a portion of the top of the packaging according to the invention;

FIG. 3 is a sectional view, taken along the line III-III of FIG. 2, of the packaging according to the invention;

FIG. 4 is an enlarged-scale front view of a detail of the packaging according to the invention;

FIG. 5 is a front view of the packaging according to the invention;

FIG. 6 is a front view of the packaging according to the invention during its opening;

FIG. 7 is a front view of a flexible film that is partially sealed longitudinally according to a second embodiment of the invention;

FIG. 8 is a front view of a flexible film as shown in FIG. 7, which is sealed also transversely so as to form a partial packaging;

FIG. 9 is a transverse sectional view, taken along the line IX-IX of FIG. 7, of an improved packaging according to the invention;

FIG. 10 is a transverse sectional view, taken along the line X-X of FIG. 8, of an improved packaging according to the invention;

FIG. 11 is a front view of a packaging according to the invention, provided by means of film as in FIGS. 7 to 10.

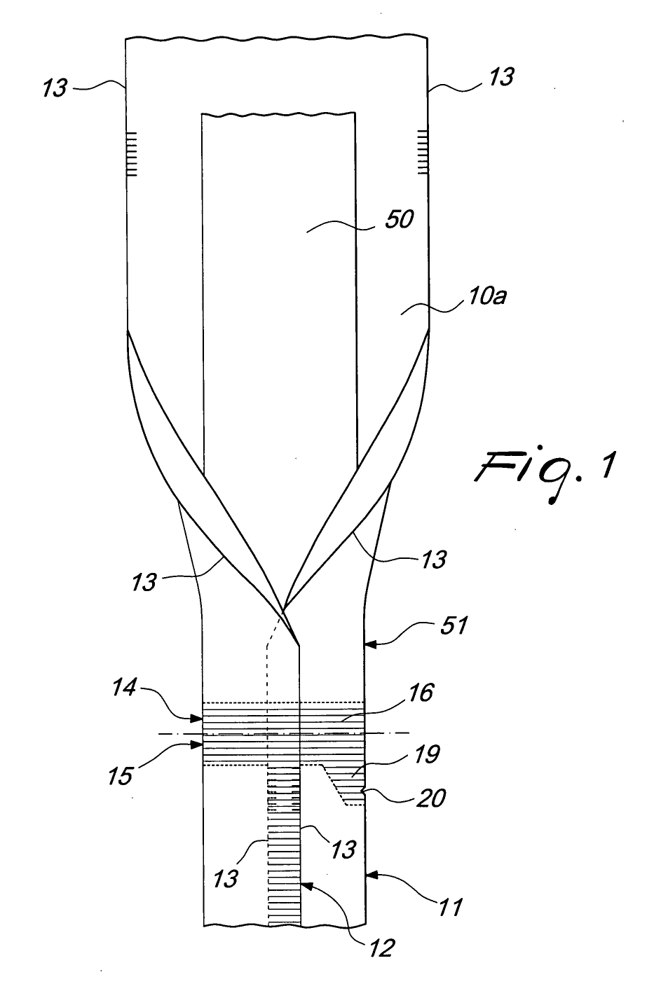

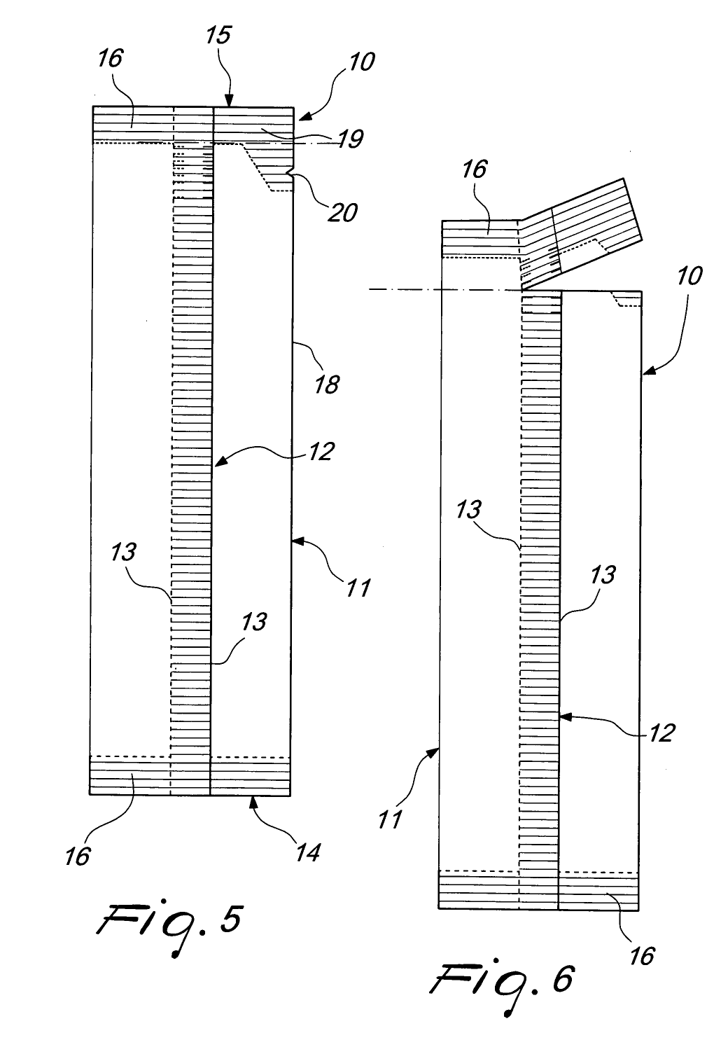

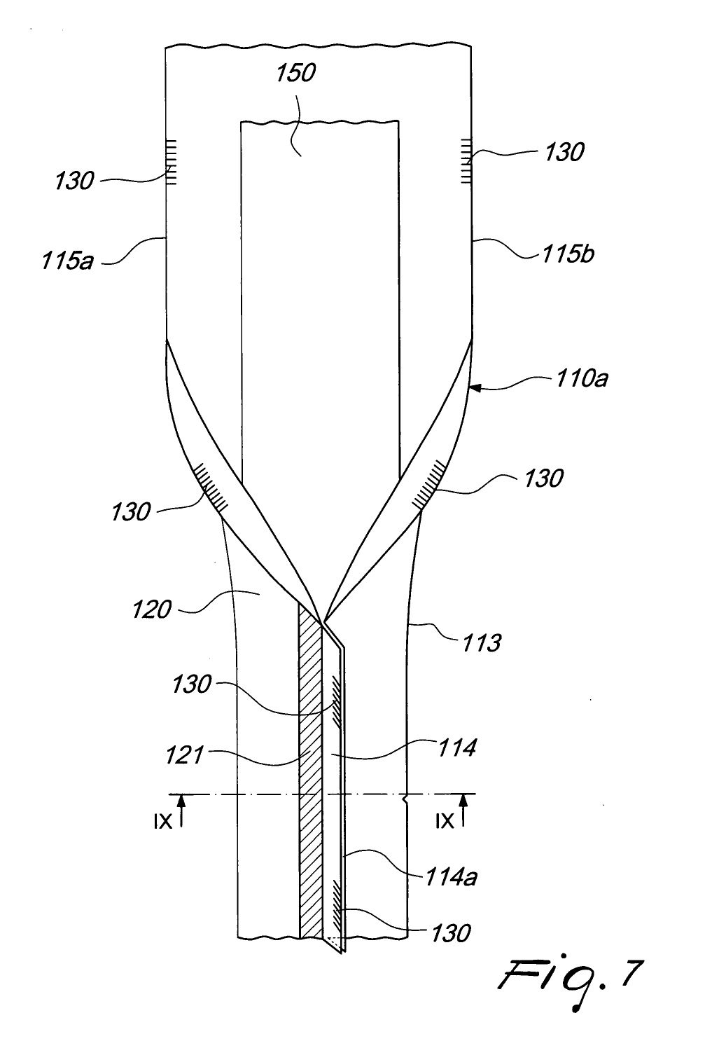

With reference to FIGS. 1 to 6, a first embodiment of a packaging of the Stickpack type with improved opening according to the invention is generally designated by the reference numeral 10.

The packaging 10 comprises a flexible single- or multilayer film 10a that forms a hermetically sealed tubular body 11.

The tubular body 11 is longitudinally provided with a first band 12 for the inside/outside sealing of mutually opposite longitudinal flaps 13 of the film.

The tubular body 11 has respective second sealing bands 16 of the inside/inside type arranged transversely on its longitudinal ends that form the bottom 14 and the top 15 of the packaging 10.

In this embodiment, a sealed extension region 19 protrudes only from the second sealing band 16 related to the top 15 of the packaging 10 on a respective portion 17 of the longitudinal edge 18 of the tubular body 11.

A weakening pre-cut 20 is provided on said sealed extension region 19.

As an alternative, it is possible to provide sealed extension regions on both mutually opposite longitudinal edges of the tubular body 11, with weakening pre-cuts on both of said sealed regions, both on the top and on the bottom of the packaging 10.

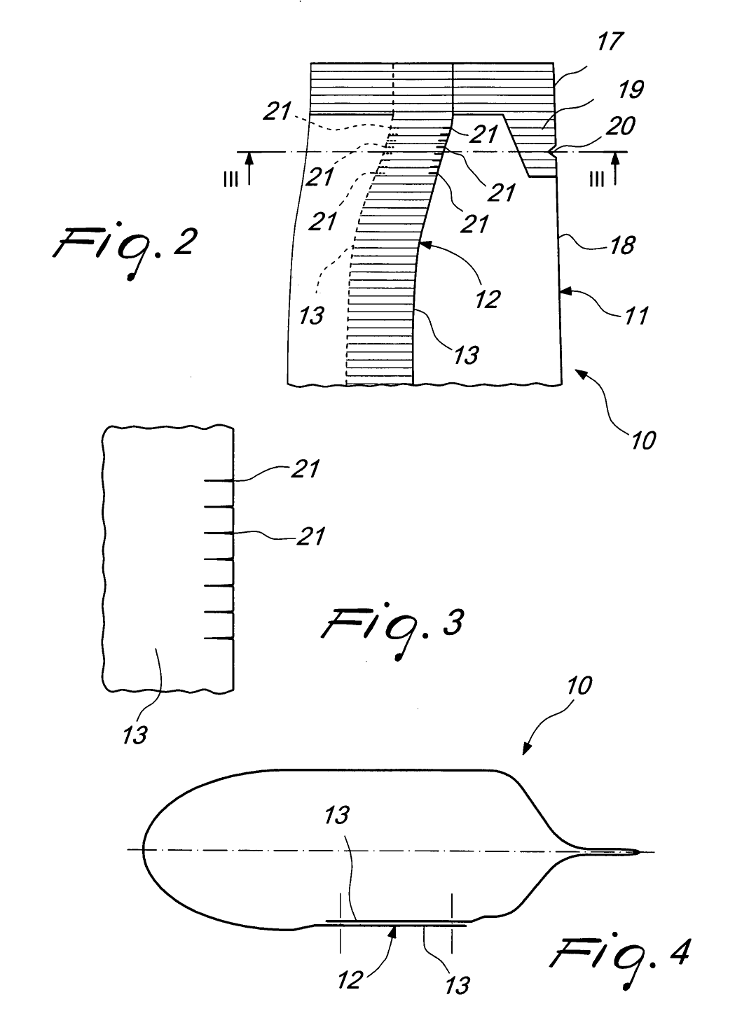

The packaging 10 further comprises, in longitudinal alignment with the sealed extension region 19, transverse weakening incisions 21 that are arranged longitudinally in series to each other and are formed longitudinally along both longitudinal flaps 13 in this embodiment (see also FIG. 4).

If the embodiment of the packaging 10 comprises sealed regions of the type 19 also on the bottom of said packaging, it is possible to provide said transverse preweakening incisions also in longitudinal alignment with said this last sealed region.

As an alternative, it is possible to provide the transverse incisions 21 on a single longitudinal flap of the film, preferably the first flap encountered by the tear that propagates from the pre-cut 20 while opening the packaging.

The longitudinal series of transverse incisions 21 preferably covers a length that is substantially equal to the longitudinal length of the sealed extension region 19.

The transverse incisions 21 are smaller than the width of the first sealing band 12, so as to avoid intersecting and impairing the seal of the packaging 10.

When one begins to open the packaging 10 by tearing it proximate to the pre-cut 20, the tear propagates in a linear fashion up to the first sealing band 12, which hinders the continuation of the opening process.

From there, thanks to the presence of the incisions 21, the tear passes beyond the band 12 without interrupting the linearity of the opening of the packaging.

In this manner, the packaging is opened correctly without scattering its content.

A method for manufacturing packagings of the Stickpack type such as the one described above comprises a step for unwinding the film from a reel and a subsequent step for folding the unwound film on a collar that forms the packaging.

With reference to FIG. 1, said forming collar allows, by way of a filler tube 50, to fill a partial packaging 51, obtained by means of the folded film, with the product (for example of the granular or powdered type) to be packaged.

The step for sealing the partial packaging by means of the already mentioned longitudinal and transverse seals, in order to obtain a hermetically sealed packaging, is then performed.

Before the step for folding said film onto the forming collar there is a step for providing the already described transverse incisions on at least one of the mutually opposite longitudinal flaps of the film.

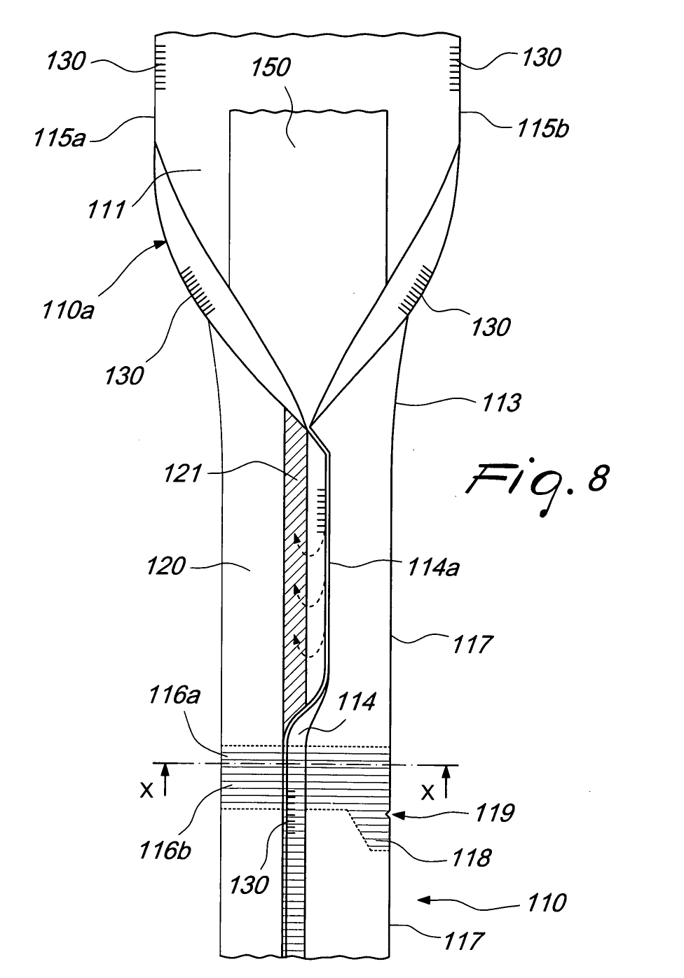

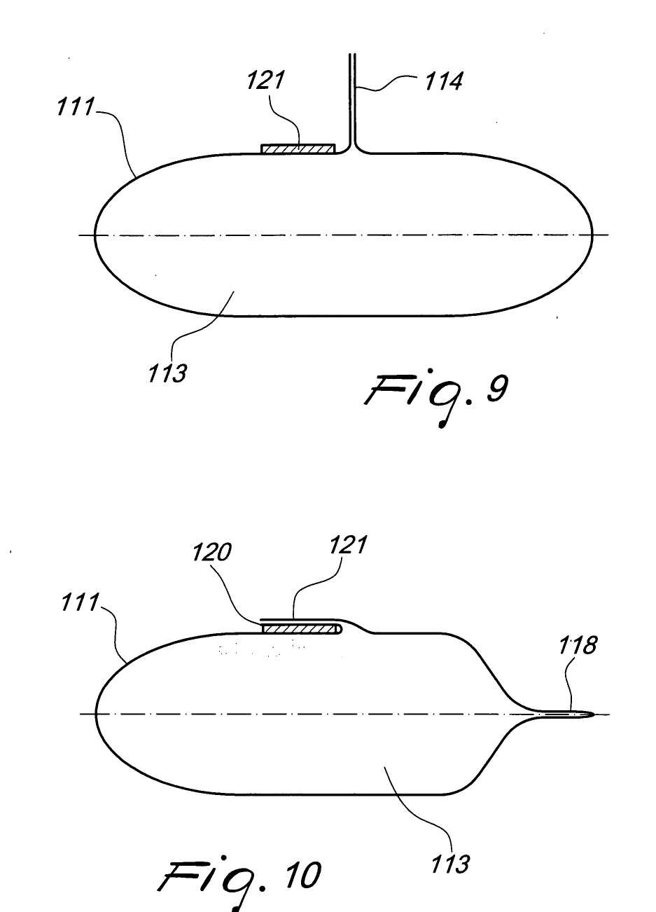

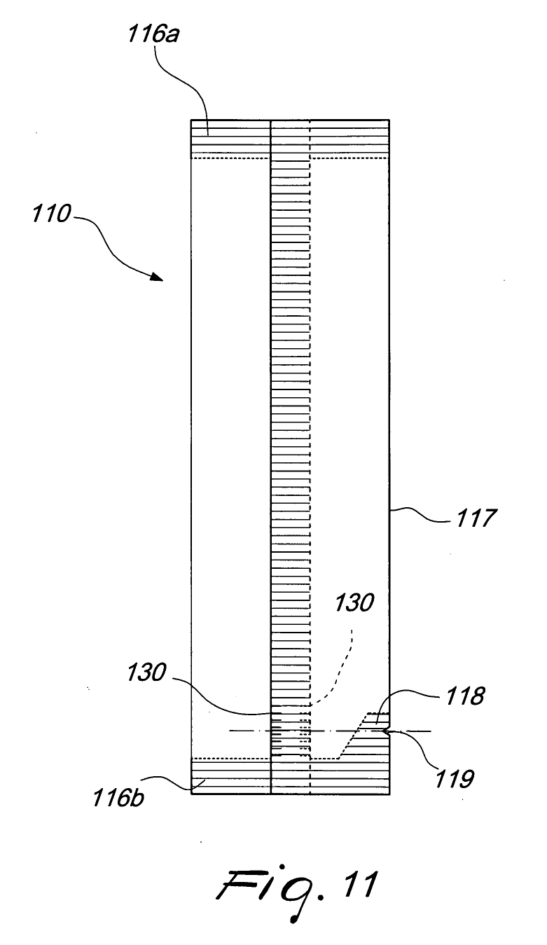

With reference to FIGS. 7 to 11, a second embodiment of the packaging of the Stickpack type with improved opening according to the invention is generally designated by the reference numeral 100.

The packaging 100 comprises a flexible single- or multilayer film 111.

The film 111 forms, when folded around a packaging-forming collar, a tubular body 113.

The tubular body 113 is sealed hermetically longitudinally by means of a first sealing band 114.

The first sealing band 114 affects the mutually opposite complementary flaps, designated respectively by the reference numerals 115a and 115b, of the film 111.

Transversely, said tubular body 113 is sealed by means of second sealing bands, designated by the reference numerals 116a for the bottom of the packaging 100 and 116b for the top of said packaging 100.

A sealed extension region 118 protrudes from one of said second sealing bands 116 along the corresponding longitudinal edge 117 of the tubular body 113.

A weakening pre-cut 119 is generally provided on said sealed extension region 118.

It is possible to provide, if so chosen, sealed extension regions on both mutually opposite longitudinal edges 115a and 115b of the tubular body 113, with pre-cuts 119 on both of said sealed regions 118, both on the top and on the bottom of the packaging 100.

In longitudinal alignment with the sealed region 118 there are transverse preweakening incisions 130, that are longitudinally in series to each other and are formed along both of the mutually opposite complementary longitudinal flaps 115a and 115b.

The second sealing bands 116a and 116b are of the inside/inside type.

The improved packaging 100 is characterized in that the first sealing band 114 is also of the inside/inside type.

The first sealing band 114, after the sealing operation, is folded and made to adhere longitudinally to the outer surface 120 of the tubular body 113 by interposing an adhesive layer 121.

The adhesive layer 121 is constituted by a thermolacquer.

In a further embodiment, such adhesive layer 121 is constituted by a sealing film.

The adhesive layer 121 is distributed along the entire length of the packaging 100, proximate to the first sealing band 114, which in this step assumes a so-called “fin” configuration and is designated by the reference numeral 114a.

The adhesive layer 121 is therefore arranged substantially at the base of said “fin” 114a.

In another constructive solution, said adhesive layer 121 is distributed only at the second transverse sealing bands 116a and 116b.

The adoption of an inside/inside seal for the first longitudinal sealing band 114 allows to eliminate the sealing problems caused by the nonuniform nature of the materials in contact in the case of outside/inside sealing with multilayer films.

Inside/inside sealing in fact affects layers of the same material both in the case of single-layer film and in the case of multilayer film.

The folding of the “fin” 114a so that it adheres to the adhesive layer 121 allows the packaging 100 to benefit from the advantages of the transverse incisions 130 in addition to maintaining a pleasant aesthetic appearance and easy handling of said packaging 100.

The incisions 130 in fact allow the tear line, which starts from the weakening pre-cut 119 provided on the edge of the packaging, to continue through said first longitudinal sealing band 114 provided by the two mutually sealed flaps 115a and 115b.

A method for manufacturing improved packagings 100 of the Stickpack type and the like, such as the one described above, comprises a first step in which the single- or multilayer film 111 is unwound.

The film 111 is then folded around the forming collar in order to provide a partial packaging, designated by the reference numeral 100a.

The collar also allows, by means of an inlet tube 150, to fill the packaging 100.

Transverse incisions 130 are provided on the film 111 prior to the folding step on at least one of the mutually opposite longitudinal flaps 115a and 115b of said film 111.

The subsequent steps consist first of all in longitudinally sealing said partial packaging 100a by means of the first sealing band 114 of said mutually opposite flaps 115a and 115b, said seal being of the inside/inside type.

The longitudinal adhesive layer 121 is then applied on the outer surface 120 of said partial packaging 100a at and proximate to the first heat-sealing band 114 in the vicinity of the base of the fin 114a.

The first sealing band 114 is folded, with respect to a longitudinal axis, from the original fin-like configuration 114a onto the outer surface 120 of the partial packaging 100a on the side of the adhesive layer 121.

The first sealing band 114 is glued to the outer surface 120 by activating the adhesive layer 121.

If the adhesive layer 121 is constituted by thermolacquer, activation of the same layer 121 is achieved by heating the thermolacquer.

The partial packaging 100a is sealed transversely by means of the second sealing bands 116a and 116b.

The weakening pre-cut 119 is provided on at least one sealed extension region 118 of at least one of the second sealing bands 116a and 116b.

In this process, the operation for gluing said first sealing band 114 to the outer surface 120 precedes the transverse sealing of the partial packaging 100a.

In a further embodiment of the method described above, said operation for gluing the first sealing band 114 to the outer surface 120 follows the transverse sealing of the partial packaging 100a.

The operation for applying the longitudinal adhesive layer 121 can be chosen continuous or intermittent.

This operation performed continuously allows to glue the “fin” 114a to the surface 120 along the entire packaging 100; intermittent gluing instead allows to glue the “fin” 114a only in the regions that are subsequently affected by the transverse seal.

The longitudinal adhesive layer 121 is conveniently arranged not outside, i.e. within the band or strip of surface affected by the first folded sealing band 114.

In practice it has been found that the invention thus described solves the problems noted in known types of Stickpack-type packaging; in particular, the present invention provides a packaging of the Stickpack type and the like with improved opening that allows transverse opening of the packaging without the risk of scattering the product contained inside.

The incisions on the first longitudinal seal in fact allow the tear of the packaging to cross said seal in a linear fashion.

Moreover, the present invention provides a packaging of the Stickpack type and the like with improved opening that is sealed perfectly and does not have lacerations or delaminations in the layers of the film that composes the packaging.

Conveniently, the transverse incisions are in fact much smaller than the width of the first sealing band, so as not to cross and impair the seal of the packaging.

Further, the present invention provides a method for manufacturing a packaging of the Stickpack type such as the one described that is economically advantageous with respect to the methods currently in use for manufacturing equivalent commercially available packagings.

Moreover, the present invention provides a method for manufacturing packagings of the Stickpack type and the like that uses machines that are simple to manufacture and derive from known systems and technologies.

The invention thus conceived is susceptible of numerous modifications and variations, all of which are within the scope of the appended claims; all the details may further be replaced with other technically equivalent elements.

In practice, the materials used, so long as they are compatible with the specific use, as well as the dimensions, may be any according to the requirements and to the state of the art.

What is claimed is:

1. A method for manufacturing packagings of the Stickpack type and the like, wherein between the unwinding of a single- or multilayer film to provide a partial packaging and the sealing of said partial packaging by means of longitudinal and transverse seals in order to obtain a hermetically sealed packaging, it consists in providing transverse incisions on at least one of the longitudinal mutually opposite flaps of said film.

2. The method according to claim 1, wherein said transverse incisions are provided after unwinding said film and before folding said unwound film onto a forming collar.

3. A method for manufacturing improved packagings of the Stickpack type and the like, wherein a single- or multilayer film is unwound to manufacture a partial packaging and transverse incisions are provided on said film on at least one of the mutually opposite flaps of said film, said method comprising the steps of:
sealing longitudinally said partial packaging by virtue of a first band of sealing of said mutually opposite flaps of the inside/inside type;
applying onto at least one portion of the outer surface of said partial packaging a longitudinal adhesive layer at and proximate to said first sealing band;
folding, with respect to a longitudinal axis, said first sealing band on the outer surface of said partial packaging on the side of said adhesive layer;
gluing said first sealing band to said at least one outer surface portion by activating said adhesive layer, transversely sealing said partial packaging with second sealing bands, and providing a weakening pre-cut on at least one sealed extension region of at least one of said second sealing bands.

4. The method according to claim 3, wherein said operation for gluing said first sealing band to said at least one outer surface portion precedes said operation for transverse sealing of said partial packaging.

5. The method according to claim 3, wherein said operation for gluing said first sealing band to said at least one outer surface portion follows said operation for transverse sealing of said partial packaging.

6. The method according to claim 3, wherein said adhesive layer is constituted by thermolacquer.

7. The method according to claims 3, wherein said activation of said adhesive layer is achieved by heating said thermolacquer.

8. The method according to claim 3, wherein said operation for applying said longitudinal adhesive layer is selectively continuous or intermittent.

9. The method according to claim 8, wherein said operation for intermittent application of said adhesive layer affects said second sealing bands.

10. The method according to claim 3, wherein said longitudinal adhesive layer is arranged not externally to the strip of surface that is affected by said first folded sealing band.
